(19) United States
(12) Patent Application Publication
(10) Pub. No.: US 2015/0286124 A1
(43) Pub. Date: Oct. 8, 2015

(54) REFLECTING SCREEN

(71) Applicant: LG ELECTRONICS INC., Seoul (KR)

(72) Inventors: Sungtae KIM, Seoul (KR); Youngsung KIM, Seoul (KR); Seunggyu LEE, Seoul (KR); Jinbeom KIM, Seoul (KR); Bokyung KANG, Seoul (KR)

(73) Assignee: LG ELECTRONICS INC., Seoul (KR)

(21) Appl. No.: 14/676,318

(22) Filed: Apr. 1, 2015

(30) Foreign Application Priority Data
Apr. 2, 2014 (KR) 10-2014-0039132

(51) Int. Cl. G03B 21/56

(52) U.S. Cl. CPC G03B 21/56

(57) ABSTRACT

Disclosed is a reflecting screen configured to reflect an image introduced from a projector. The reflecting screen includes a black resin layer having a dark color, wherein the black resin layer includes a plurality of slopes formed at one surface thereof so as to face in a given direction, the slopes being arranged in the vertical direction, and stepped portions formed between the slopes, corrugations formed at the slopes, and a reflecting layer formed at the slopes of the black resin layer. The reflecting screen is capable of reducing raw material costs and manufacturing costs and reducing the weight and volume of a product, as a result of simplifying a multilayered structure of a reflecting screen.

This application claims the benefit of Korean Patent Application No. 10-2014-0039132, filed on Apr. 2, 2014, which is hereby incorporated by reference as if fully set forth herein.

### BACKGROUND OF THE INVENTION

1. Field of the Invention

The present invention relates to a reflecting screen which is capable of providing a horizontal viewing angle and increase brightness thereof.

2. Discussion of the Related Art

A projector projects an image to a screen and a user views light reflected by the screen. When using a conventional projector using projection from a remote distance, an image projected from the projector may be reflected by a screen to thereby be transmitted to a user based on symmetry of an angle of incidence and a reflection angle.

In the case of a recent short focus projector that projects an image at a short distance, it has a greater angle of incidence than the conventional projector because light is introduced at a distance close to a screen. Such a great angle of incidence entails a great reflection angle, causing most light to be reflected to the ceiling rather than being reflected to the user's eyes, which may problematically cause a user to see a significantly dark image. Moreover, in the case of a 3D image, a reflection angle of the image may deviate from a position of stereoscopic glasses, which makes it impossible to see the 3D image.

In addition, an upper portion and a lower portion of the screen have different reflection directions due to a great difference between angles of incidence thereof. The conventional screen has difficulty in being applied to the short focus projector due to deterioration of contrast in a bright room, non-uniformity in the distribution of brightness throughout a screen surface, and difficulty in provision of a broad viewing angle.

### SUMMARY OF THE INVENTION

Accordingly, the present invention is directed to a reflecting screen that substantially obviates one or more problems due to limitations and disadvantages of the related art.

An object of the present invention is to provide a reflecting screen which is capable of providing a vivid screen via differentiated angles of slopes and achieving light weight and low manufacturing costs owing to a simplified multilayered structure thereof.

Additional advantages, objects, and features will be set forth in part in the description which follows and in part will become apparent to those having ordinary skill in the art upon examination of the following or may be learned from practice. The objectives and other advantages may be realized and attained by the structure particularly pointed out in the written description and claims hereof as well as the appended drawings.

To achieve these objects and other advantages and in accordance with the purpose of the invention, as embodied and broadly described herein, in accordance with an aspect of the present invention, reflecting screen configured to reflect an image introduced from a projector, the reflecting screen includes a black resin layer having a dark color, wherein the black resin layer includes a plurality of slopes formed at one surface thereof so as to face in a given direction, the slopes being arranged in the vertical direction, and stepped portions formed between the slopes, corrugations formed at the slopes, and a reflecting layer formed at the slopes of the black resin layer.

The slopes may be gradually reduced in inclination angle thereof toward the given direction.

The given direction facing the slopes may be an upward or downward direction and the slopes may extend in the horizontal direction and be arranged side by side in the vertical direction.

The given direction facing the slopes may be an upward or downward direction and the slopes may have an arc shape about an upper or lower end and be arranged side by side in the vertical direction.

It is to be understood that both the foregoing general description and the following detailed description of the present invention are exemplary and explanatory and are intended to provide further explanation of the present invention as claimed.

### BRIEF DESCRIPTION OF THE DRAWINGS

The accompanying drawings, which are included to provide a further understanding of the present invention and are incorporated in and constitute a part of this application, illustrate embodiment(s) of the present invention and together with the description serve to explain the principle of the present invention. In the drawings:

FIG. 1 is a sectional view of a reflecting screen according to the present invention;

FIG. 2 is a view illustrating a reflecting screen according to one embodiment of the present invention;

FIG. 3 is a view illustrating a reflecting screen according to another embodiment of the present invention; and

FIG. 4 is a sectional view of a conventional reflecting screen.

### DETAILED DESCRIPTION OF THE INVENTION

Hereinafter, a reflecting screen according to the present invention will be described in detail with reference to the accompanying drawings. With respect to constituent elements used in the following description, suffixes “module” and “unit” are given or mingled with each other only in consideration of ease in the preparation of the specification, and do not have or serve as different meanings.

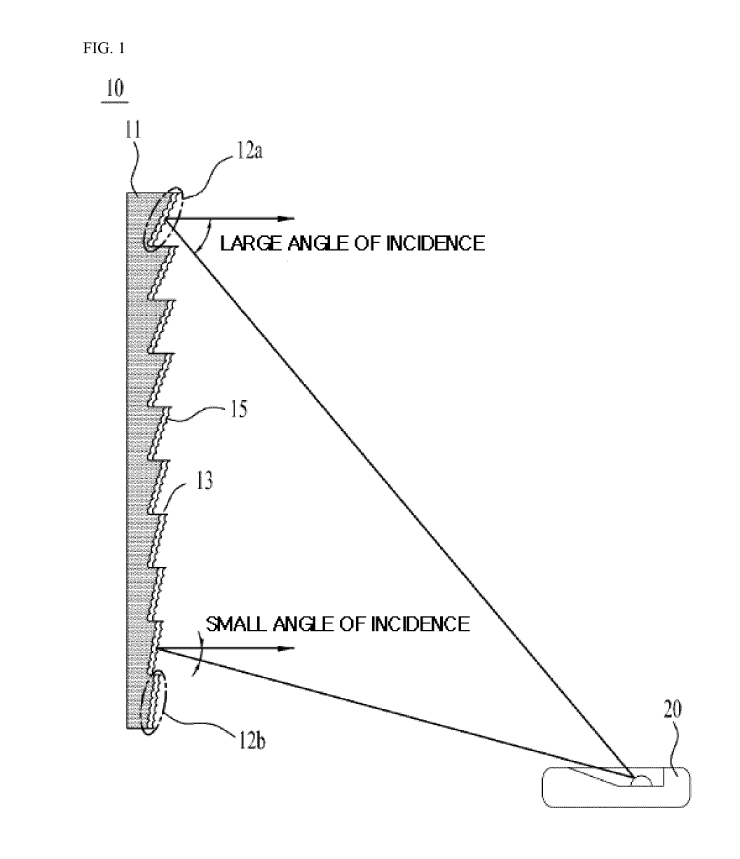

FIG. 1 is a sectional view of a reflecting screen 10 according to the present invention and illustrates a short focus projector 20, in addition to the reflecting screen 10.

The short focus projector 20 is configured to project an image at a short distance from the reflecting screen 10. An image introduced from the short focus projector 20 to the reflecting screen 10 is reflected forward to thereby reach a user. When light is introduced at a short distance, the light is reflected to the ceiling due to a large angle of incidence. The reflecting screen 10 may employ a lens layer having slopes 12a and 12b which are capable of reflecting light forward.

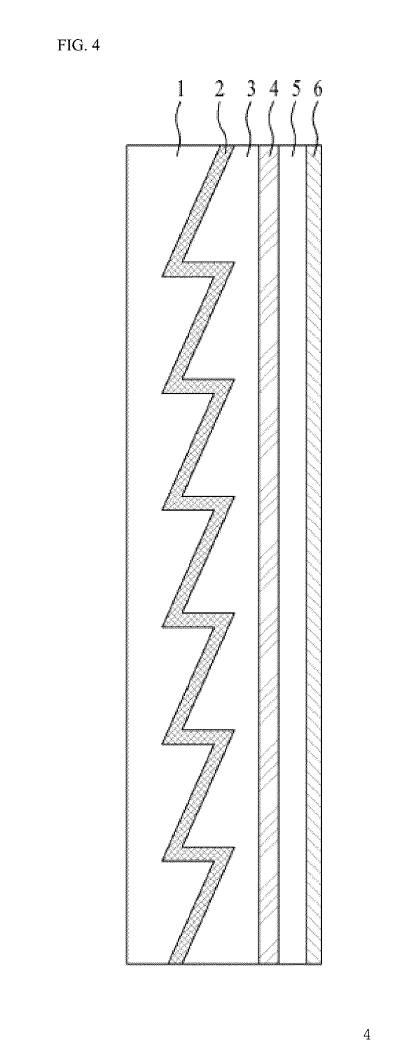

FIG. 4 is a sectional view of a conventional reflecting screen. In the conventional reflecting screen, a transparent lens layer 3 having slopes at a rear surface thereof is used and the slopes are coated with a reflecting layer 2.

The reflecting screen needs low black brightness in order to enable viewing of the reflecting screen in a bright place. To achieve the low black brightness, the conventional reflecting screen includes a colored layer 4 stacked on a front surface of the lens layer 3. The black brightness refers to the expression degree of dark colors. A more vivid image can be acquired as the black brightness is reduced.

In addition, the conventional reflecting screen includes a diffusion layer 5 to enable simultaneous viewing by several persons. That is, the diffusion layer 5 may be located at a front surface of the colored layer 4 or between the colored layer 4 and the lens layer 3 in order to achieve a viewing angle. Coating layers 1 and 6 may be further formed to protect the reflecting layer 2 and the diffusion layer 5.

However, a multilayered structure composed of the lens layer 3, the colored layer 4 and the diffusion layer 5 has great loss of light as the light passes therethrough, thus suffering from reduction in brightness and resolution as well as increase in the volume and weight of a product.

Therefore, the present invention provides the reflecting screen 10 which is capable of reducing manufacturing costs and reducing the size and weight of a product via omission of the lens layer 3, the colored layer 4 and the diffusion layer 5. As exemplarily illustrated in FIG. 1, the reflecting screen 10 of the present invention is composed of a black resin layer 11 and a reflecting layer 15.

The black resin layer 11 includes particles of dark colors and generally has a dark color. The black resin layer 11 has a plurality of slopes 12a and 12b vertically arranged at a front surface thereof, the respective slopes 12a and 12b being oriented to face upward or downward.

The slopes 12a and 12b are oriented to face upward when the short focus projector 20 is located above the reflecting screen 10. The slopes 12a and 12b are oriented to face downward when the short focus projector 20 is located below the reflecting screen 10. For convenience of description, the case where the short focus projector 20 is located below the reflecting screen 10 and the slopes 12a and 12b are oriented to face downward will be described below.

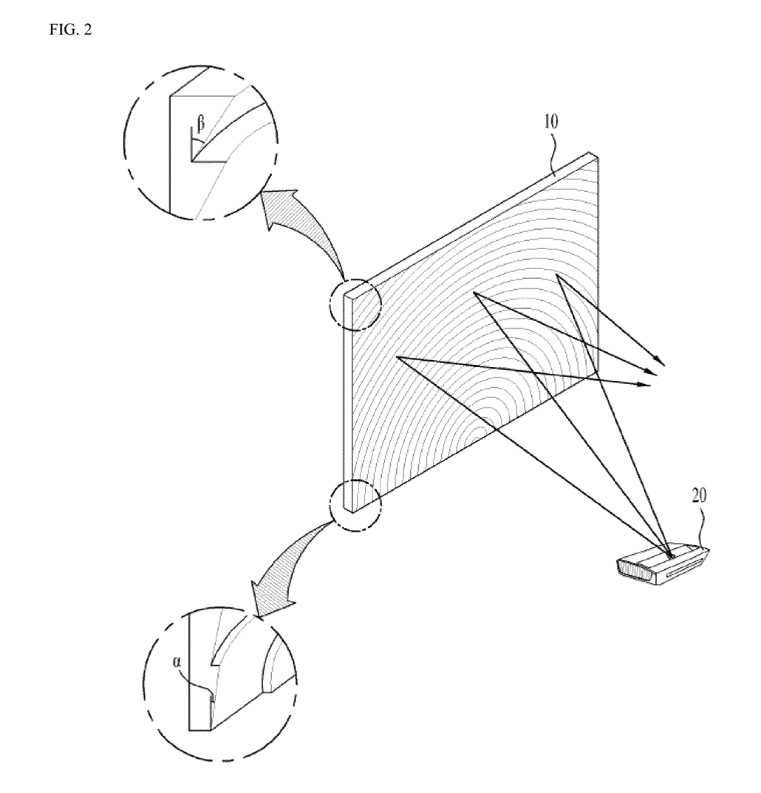

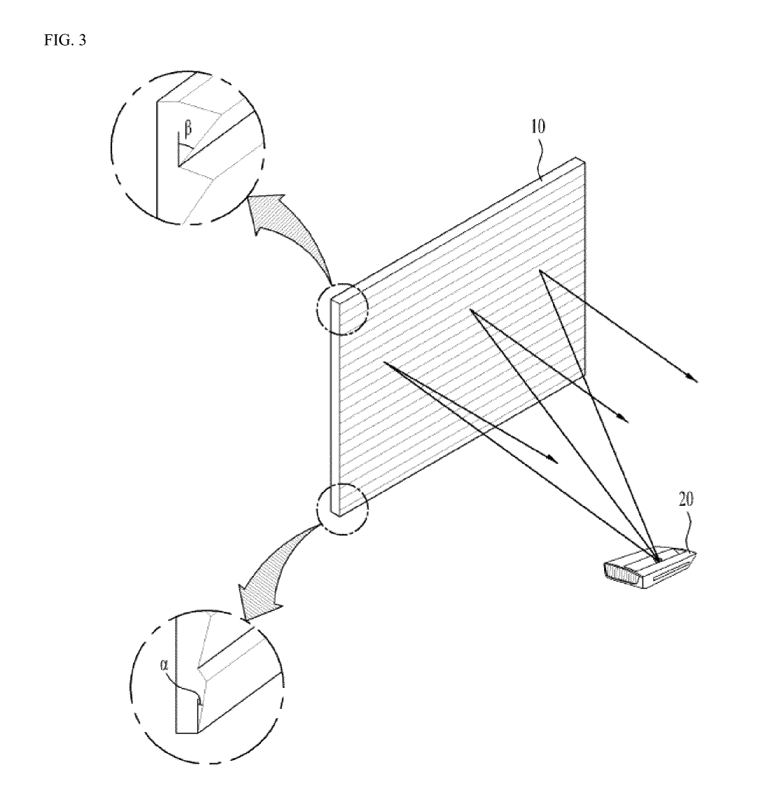

FIG. 2 is a view illustrating the reflecting screen 10 according to one embodiment of the present invention and FIG. 3 is a view illustrating the reflecting screen 10 according to another embodiment of the present invention. The slopes 12a and 12b formed at the black resin layer 11 may have an arc shape as exemplarily illustrated in FIG. 2, or may have a laterally extending band shape as exemplarily illustrated in FIG. 3.

In the case of the arc shaped slopes 12a and 12b as illustrated in FIG. 2, they have an advantage of centrally concentrating light, but suffer from disadvantageous variation in the resolution of an output image according to a position of the user. On the other hand, in the case of the linear slopes 12a and 12b as illustrated in FIG. 3, they may provide a wide horizontal viewing angle although they cause deterioration in brightness, thus having difficulty in allowing several persons to simultaneously see an image projected from the projector.

The slopes 12a and 12b are arranged side by side in the vertical direction and stepped portions 13 are formed between the slopes 12a and 12b. The stepped portions 13 generally have flat surfaces. The reflecting layer 15 is coated over the slopes 12a and 12b of the black resin layer 11 to reflect light introduced to the slopes 12a and 12b, thereby supplying the light to the user who is located in front of the reflecting screen 10. At this time, the reflecting layer 15 is not formed at the stepped portions 13 such that the stepped portions are exposed outward.

A dark portion of the black resin layer 11 exposed through the stepped portions 13 absorbs external light, thereby preventing reduction in the brightness of an image. That is, the stepped portions 13, which are exposed dark portions at the front surface of the black resin layer 11, enable omission of the colored layer 4 of the conventional reflecting screen.

The slopes 12a and 12b formed with the reflecting layer 15, as exemplarily illustrated in FIG. 1, may be provided with corrugations. The corrugations serve to increase the viewing angle by scattering light, thereby enabling omission of the diffusion layer 5 of the conventional reflecting screen.

The slopes 12a and 12b are arranged in the vertical direction and the slopes 12a and 12b at an upper portion and the slopes 12a and 12b at a lower portion have a difference in the angles of incidence of light projected from the short focus projector 20. To compensate for this difference, the slopes 12a and 12b at the upper portion and the lower portion according to the present invention may have different inclination angles.

As exemplarily illustrated in FIGS. 1 to 3, the slopes 12a and 12b located at the upper portion have a large inclination angle β, whereas the slopes 12a and 12b located at the lower portion have a small inclination angle α. Such a difference in inclination angle may provide the user with an entire image regardless of the angle of incidence.

As is apparent from the above description, according to at least one embodiment of the present invention, it is possible to reduce raw material costs and manufacturing costs and to reduce the weight and volume of a product, as a result of simplifying a multilayered structure of a reflecting screen.

Effects that are obtainable through the present invention are not limited to the aforementioned effects and other effects not mentioned will be clearly understood from the above description by those skilled in the art.

Although the exemplary embodiments have been illustrated and described as above, of course, it will be apparent to those skilled in the art that the embodiments are provided to assist understanding of the present invention and the present invention is not limited to the above described particular embodiments, and various modifications and variations can be made in the present invention without departing from the spirit or scope of the present invention, and the modifications and variations should not be understood individually from the viewpoint or scope of the present invention.

What is claimed is:

1. A reflecting screen configured to reflect an image introduced from a projector, the reflecting screen comprising:
a black resin layer having a dark color, wherein the black resin layer includes a plurality of slopes formed at one surface thereof so as to face in a given direction, the slopes being arranged in the vertical direction, and stepped portions formed between the slopes;
corrugations formed at the slopes; and
a reflecting layer formed at the slopes of the black resin layer.

2. The reflecting screen according to claim 1, wherein the slopes are gradually reduced in inclination angle thereof toward the given direction.

3. The reflecting screen according to claim 1, wherein: the given direction facing the slopes is an upward or downward direction; and
the slopes extend in the horizontal direction and are arranged side by side in the vertical direction.

4. The reflecting screen according to claim 1, wherein: the given direction facing the slopes is an upward or downward direction; and
the slopes have an arc shape about an upper or lower end and are arranged side by side in the vertical direction.
